(19) United States
(12) Patent Application Publication
(10) Pub. No.: US 2025/0180164 A1
(43) Pub. Date: Jun. 5, 2025

(54) CONDENSATE DRAIN, SENSOR DEVICE, AND METHOD FOR DETECTING THE STATE OF A FLOW PATH

(71) Applicant: GESTRA AG, Bremen (DE)

(72) Inventors: Sergej JANZEN, Schiffdorf (DE); Ben-Noah NEUBERT, Bremen (DE)

(21) Appl. No.: 18/832,043

(22) PCT Filed: Jan. 24, 2023
(86) PCT No.: PCT/EP2023/051651

§ 371 Date: Jul. 22, 2024

(30) Foreign Application Priority Data
Jan. 24, 2022 (DE) 10 2022 101 585.8

(51) Int. Cl. F16T 1/48; F16T 1/38

(52) U.S. Cl. CPC F16T 1/48; F16T 1/383

(57) ABSTRACT

A control fitting is disclosed for controlling the flow-through of fluids, in particular a condensate drain for discharging liquid condensate, with a housing with an inlet flange and an outlet flange, and a sensor device fastened to the housing for monitoring the operating state of the control fitting, wherein the sensor device has a coupling assembly for coupling to the housing. The sensor device has a sensor for detecting structure-borne sound, and the coupling assembly is connected in a positive and/or non-positive manner to the sensor and is configured for establishing a releasable, positive and/or non-positive connection to the housing, in order to conduct the structure-borne sound of the housing to the sensor in the mounted state. A sensor device for such a control fitting and a method for detecting a state or a blockage and/or leakage of a flow path are also disclosed.

The present invention relates to a condensate drain for draining liquid condensate with a housing with an inlet flange and an outlet flange and a sensor device fastened to the housing for monitoring the operating state of the control fitting, wherein sensor device has a coupling assembly for coupling to the housing.

Control fittings of the above-mentioned type, such as, for example, condensate drains, are well known. They are used for controlling the flow-through of fluids in lines, containers, pipe systems or the like. In many plants of the chemical, pharmaceutical and energy-related industry, water vapor is used as heat transfer medium, which is conducted through corresponding pipe systems and control fittings. For the most part, the water vapor is thereby provided centrally at different pressure stages, for example by a steam generator. By performing work due to steam losses, heat losses or the like during the respective applications, condensation of a portion of the steam occurs due to the energy transfer. Instead of water vapor, other media can also be used, which can be present in the steam phase and or the liquid phase. In the case of many applications, the liquid phase, the condensate, is to be separated and discharged, whereby so-called condensate drains or drains, in short, are used in many cases. In the case of some processes, steam hammering can occur, for example. During the steam hammering, steam bubbles suddenly collapse in a cooler liquid environment. In order to prevent this as well and in order to ensure an effective energy use, condensate has to be removed from the system early on. For the most part, this takes place by means of said condensate drains. During the return of condensate into the system, condensate drains are also used in order to ensure that only water is located in the lines, which are still pressurized, for the return. Different types of condensate drains are known. They have a closure element in common, which is configured for selectively blocking or releasing the flow path, respectively, within the condensate drain and a discharge line for draining condensate. Mechanical (float) condensate drains utilize the physical properties of the steam and of the water. A, for example, spherical float, which actuates or opens a valve, respectively, when the condensate water and thus the float rises, is used as closure element. Other closure elements comprise bimetals or membranes, which control the opening and closing of the closure element as a function of temperature.

For example, signs of wear, contaminations and/or deposits and further the formation of magnetite due to washout of the transported steam or condensate, respectively, can occur in such plants. Leakages or blockages can thus occur in the condensate drains used in the plants.

During ongoing operation, a leakage leads to steam losses and thus lowers the efficiency of the respective plant. This leads to significant costs, so that there is the need for an early detection of leakages. Periodic maintenance intervals are thus often performed. The standstill times of the respective plant are thus increased, which is disadvantageous. A failure rate of defective condensate drains in a magnitude of 15 to 25% is to typically be expected in plants without periodic testing or maintenance, respectively. By means of tests, which are to be performed periodically, this failure rate can be reduced significantly.

Due to the high pressurization of the control fittings, such as, in particular, of the condensate drains, it is further also mandatory to detect a blockage or onset of clogging of the flow path, respectively, for safety reasons, in order to prevent damages to the respective plant and the entire production operation, for example due to explosions caused by the water steam flowing at a high speed, which can entrain condensate water drops at high speeds. There is a need for an early detection of leakages and blockages because, for example, blocking condensate drains can lead to significant reductions of the performance of the respective plant and leaky condensate drains result in steam losses, which, in turn, represent a significant economic loss. A pressure increase in condensate networks, thus in a system with several condensate drains, is to further be expected. Difficulties caused thereby during the draining can then occur at several condensate drains in the system. A banking-up of condensate can additionally also develop, which can cause water hammering and which can additionally lead to significant damages to the system. Water hammering hereby refers to a pressure surge, which is caused by a rapid change of the flow speed in the pipeline.

Sensor devices are known, which, for example in the region of the condensate drain or other control fittings, detect vibrations or temperatures, respectively, the change of which allow drawing conclusions to leakages or blockages. However, sensor devices of this type react in a highly sensitive manner to interference variables during the operation of the plants, such as, for example, fundamental vibrations of the plants or also operational temperature fluctuations. Due to this, sensor devices of this type are constructed in a highly complex manner for the most part, in order to minimize the impact of interference variables. A sensor device of this type is disclosed, for example, in the WO 2019/003692 A1. In the case of this device, a probe tip rests against the housing, wherein the vibrations of the housing stimulate a relative movement of the probe tip relative to a piezoelectric sensor. In addition to the complex setup, the increased susceptibility to wear and a contamination of the moving probe tip, which is in direct contact with the housing, is a disadvantage thereby. Other sensor devices sometimes provide only inaccurate measuring results because the sensor signals are strongly influenced by interference variables.

It is the object of the present invention to overcome at least one of the disadvantages known from the prior art. It is in particular the object of the present invention to increase the reliability and robustness of sensor devices for monitoring the operating state of control fittings and to thus improve the safety and operating time of control fittings, in particular condensate drains of the above-mentioned type, as a whole. Plant standstill times at the respective control fittings are to in particular also be minimized and operating states are to be monitored.

In a first aspect, the present invention solves the above-mentioned object by means of a control fitting with the features according to claim 1.

According to the first aspect of the invention, the control fitting is a condensate drain with a flow path formed between the inlet flange and the outlet flange, wherein a closure element is arranged in the flow path, which is configured for selectively blocking and/or for connecting the flow path. With regard to the first aspect, the invention solves the above-mentioned object in that the sensor device is arranged downstream from the closure element and comprises: a sensor for detecting structure-borne sound and/or a sensor for detecting the temperature of the coupling assembly and/or of the housing, wherein the sensor device is configured for detecting a leakage of the condensate drain by detecting the structure-borne sound of the coupling assembly and/or of the housing and/or for detecting a blockage of the flow path by detecting the temperature of the coupling assembly and/or of the housing. The inventors recognised in an advantageous manner that in a condensate drain, the influencing of the structure-borne sound is greatest downstream from the closure element in the event of a leakage because the intensity of the structure-borne sound is greatest in this region, for example due to turbulences.

The coupling assembly is preferably connected in a positive and/or non-positive manner to the sensor and is configured for establishing a releasable, positive and/or non-positive connection to the housing, in order to conduct the structure-borne sound of the housing to the sensor in the mounted state. Sound, which propagates in a solid body, is referred to as structure-borne sound. In addition to normal stresses, a solid body can also absorb shear stresses, so that structure-borne sound or structure-borne sound waves, respectively, can propagate as longitudinal waves and transversal waves. The sensor is preferably configured for detecting the longitudinal waves and/or transversal waves in the coupling assembly. Maintenance intervals thus do not need be performed routinely any longer but can take place as needed on the basis of the sensor signals. The standstill times of the respective plant are thus reduced effectively and the safety of the control fitting is increased during operation. The invention in particular also makes a contribution to the preventative maintenance, to the process monitoring, the detection and localization of defects in plants and in the components thereof, such as, in particular control fittings. The rapid detection in particular of leakages further leads to a higher efficiency of any plants, which have the control fitting because steam losses and thus energy losses can be eliminated early.

The inventors utilize in an advantageous manner that fluids, which flow through the control fitting, cause structure-borne sound of a defined frequency range as a function of the pressure, of the flow speed and of the set operating state, in particular aggregate state and in composition of the medium. A change of the structure-borne sound of the housing thus indicates a change of the flow or of the pressure, respectively, within the control fitting in a reliable manner and makes it possible to draw conclusions to the operating state of the control fitting and in particular leakages in a reliable manner. By means of the coupling assembly according to the invention, which is coupled to the housing in a releasable manner by means of a positive and/or non-positive connection, a body-sound-conducting connection is created, which is releasable, if necessary. Due to the fact that the sensor is not connected directly to the housing but that it is only connected indirectly to the housing via the assembly so as to conduct structure-borne sound, the sensor is in particular shielded thermally. By means of the coupling assembly, which ensures the coupling of the sensor device to the housing as well as the conductance of the structure-borne sound towards the sensor, the setup of the sensor device can be simplified as a whole. In other words, the functional integration of the coupling assembly as means for mechanically coupling and means for conducting the measured variable to be detected simplifies the setup of the sensor device. The positive and/or non-positive connection between the coupling assembly and the sensor as well as the coupling assembly and the housing further ensures a robust setup of the sensor device. The connection by means of positive and/or non-positive connection is further suitable for conducting structure-borne sound and provides for a reversible mounting of the individual components. In contrast to known devices, the structure-borne sound is conductive all the way to the actual sensor and is not clad into a relative movement of interconnected components in the meantime. The mechanical wear is thus reduced.

According to the invention, the term of the control fitting is to be understood to be a structural unit for conducting fluids, in particular gases and liquids or mixtures thereof, which influence the flows of these fluids. Examples for this are valves, fittings and condensate drains, but also pumps, for example. According to the invention, the term flange is to be understood so that it provides for a coupling of the control fitting to adjacent structural elements, in particular pipes; this can take place, for example, by means of several bolts, which are inserted through flange rings, but alternatively also by means of other connecting elements or sleeves, including welded joints, in the case of which no flange rings are used.

According to the invention, two sensors can also be used, for example one sensor for detecting structure-borne sound, a further sensor for detecting a further physical variable for monitoring the operating state of the control fitting.

The coupling assembly preferably extends in a longitudinal direction from the housing to the sensor and the sensor is configured for detecting longitudinal waves.

The coupling assembly preferably has a thermal insulator, which is configured for reducing the heat transmission from the housing to the sensor. In terms of the invention, a thermal insulator is a solid, liquid or gaseous insulating material, which inhibits the heat transfer. The reduction of the heat transmission by means of a thermal insulator offers additional protection of the sensor or of the sensors, so that the detection of structure-borne sound or the operation of the sensor as a whole, respectively, is not prevented by means of the temperatures within the flow path of the control fitting because sensors for detecting structure-borne sound can frequently only be operated in defined temperature ranges.

Heat transmission or heat transport is the transport of energy in the form of heat beyond at least one thermodynamic system boundary. The insulator for reducing the heat conduction from the housing to the sensor is preferably at least partly configured via the coupling assembly. The heat transmission by means of heat conduction takes place in the direction of the locations with lower temperatures by means of mechanical contact.

Further preferably, the housing has a flow path, which is formed at least in sections between inlet flange and outlet flange, wherein the sensor device is configured for detecting a leakage of the flow path by means of the sensor by detecting the structure-borne sound of the housing. The inventors recognized that a leakage of the flow path within the control fitting, but also in adjacent pipe sections of a pipeline system, has different effects on the flowing fluid The leakage thus causes, for instance, a pressure drop, a change of the flow speed and change of the aggregate state and of the composition of the medium, which causes a change of the structure-borne sound of the housing of the control fitting. A leakage can thus be detected in a reliable manner within the control fitting but also of a pipe system coupled to the control fitting.

The sensor is preferably a piezoelectric sensor. Piezoelectric sensors operate with the piezoelectric effect and are suitable, for example, for determining acceleration, stresses or forces. Due to the structure-borne sound-conducting connection of the housing to the sensor by means of the coupling assembly, the sensor is exposed to mechanical vibrations due to the structure-borne sound. Due to the structure-borne sound, a mechanical deformation of piezo elements of the piezoelectric sensor and thus in particular a shifting of the electrical polarization at the metallized surface of the respective piezo element occurs, whereby a surface tension or charge, respectively, develops, which can be used technically as measurable electrical signal. In the case of passive piezoelectric sensors, such as acceleration or sound emission transducers, this effect is used, for instance, to detect structure-borne sound. The piezoelectric sensor particularly preferably comprises at least one first piezo element and a second piezo element and preferably a pair of electrodes. By means of the combination of at least two piezo elements, the measuring accuracy is further increased. The piezoelectric sensor preferably has a seismic mass, which is configured for moving relative to the first piezo element and/or the second piezo element as a function of the structure-borne sound transmitted by the housing. The piezoelectric sensor further preferably has a front conductor, which is spaced apart from the seismic mass and which is coupled to the coupling assembly and which is configured for arranging the first piezo element and the second piezo element relative to the seismic mass.

According to a preferred embodiment, the coupling assembly has a holding part, which is connected to the housing so as to at least indirectly conduct structure-borne sound. The holding part is preferably configured for the positive and/or non-positive connection to the sensor and for the at least indirect connection to the coupling part.

The holding part is further preferably configured for the positive and/or non-positive connection of the seismic mass and of the front conductor in such a way that the at least one first piezo element and preferably at least one second piezo element are received between the seismic mass and the front conductor. The piezo elements with the front conductor and the seismic mass and preferably the electrodes can thus be arranged so as to be biased. Due to the fact that the seismic mass as well as the front conductor are connected to the housing so as to conduct structure-borne sound by means of the holding part, the one or the several piezo elements experience compressive forces and provide a measurable stress in particular at the electrodes thereof. The change of this stress indicates a change of the structure-borne sound of the housing and thus provides for the monitoring of the operating state of the control fitting.

The seismic mass preferably engages with the holding part in a movable manner and the coupling assembly further comprises a clamping part, which is coupled to the holding part and which is configured for transmitting structure-borne sound to the seismic mass, so that the seismic mass moves relative to the first piezo element and/or the second piezo element.

According to a preferred embodiment, the thermal insulator is formed from a solid insulation material and is arranged between the sensor and the housing. The sensor is thermally shielded in an effective manner with respect to the coupling assembly by means of the thermal insulator made of a solid insulation material. The heat conductivity of the thermal insulator of a solid insulation material is preferably smaller than the heat conductivity of air, so that the thermal shielding of the sensor is further improved.

According to a further preferred embodiment, the coupling assembly has a coupling part, which engages with a corresponding coupling interface of the housing, and a holding part, which is configured for coupling to the sensor. A division of functions can thus be realized by means of the coupling part and the holding part, and the complexity of the coupling assembly or of the individual parts of the coupling assembly, respectively, can be reduced.

The coupling assembly preferably has a coupling part, which can be brought into engagement with a corresponding coupling interface of the housing in a releasable manner and which is coupled to the holding part so as to conduct structure-borne sound. A needs-based material selection can thus take place by means of the division of functions and the coupling part can be formed, for example, from a temperature-resistant material or optionally so as to be particularly resistant to chemicals due to the direct arrangement on the housing. For weight or cost reasons, the holding part, in contrast, can be made of a different material.

In a second aspect, the present invention solves the above-mentioned object by means of a condensate drain with the features according to claim 5.

According to the second aspect, which is simultaneously a preferred exemplary embodiment according to the first aspect, the invention proposes in particular that the coupling assembly has a or the coupling part, respectively, which is configured for the releasable connection to the housing, and an adapter, which is configured for connecting the sensor to the coupling part so as to conduct structure-borne sound and/or in a temperature-conductive manner. The complexity of the coupling part can be reduced by means of an additional adapter. The adapter is furthermore exposed to smaller thermal loads, so that the indirect coupling of the sensor to the coupling part via the adapter protects the sensor. The coupling part can preferably be a simple screw, which has a head section with a coupling receptacle. Such a coupling receptacle can be provided, for example, by means of a threaded bore or an external contour, for example an external thread. The coupling part can thus be formed by means of a simple and robust standard part, and the adapter, which is exposed to smaller loads, can take over the functional integration, namely the reception of the sensor and connection to the coupling part.

Preferred embodiments of the control fitting according to the first aspect of the invention are likewise preferred embodiments with regard to the second aspect of the invention and reference is made to the above description of the advantages and possible designs associated therewith. It is to be understood thereby that the condensate drain according to the second aspect can also be a control fitting in general.

The coupling assembly preferably further has a or the holding part, respectively, which is coupled to the sensor, wherein the adapter is configured for the positive and/or non-positive connection to the holding part. The adapter thus connects the coupling part and the holding part to one another. The holding part can accordingly also be designed in a structurally simple manner, for example as a screw. The adapter thereby has corresponding mounting interfaces for positive and/or non-positive connection to the holding part and the coupling part.

The coupling part and the holding part further preferably have a metallic material and the adapter has a non-metallic material, in particular a technical ceramic and/or a polymer or is made completely of such a material, respectively. The holding part and the coupling part can thus be made cost-efficiently, for example of steel. In particular in the case of the coupling part, a metallic material provides advantages with regard to the heat conduction. The good heat conduction of metallic materials provides for a more exact detection or more exact conclusions, respectively, to the temperature of the housing by detecting the temperature of the coupling part. The adapter, which connects the holding part to the coupling part, can be made of an insulating material and, for example, of a polymer, so that a large freedom of design is provided with regard to manufacturing technology. The adapter can be, for example, an injection moulded part.

The holding part further preferably extends along a longitudinal axis with a length, wherein the adapter has an adapter mounting interface, in particular a threaded bore or an external thread, which is configured for being engaged with the holding part along at least ⅓ of the length of the holding part. The holding part is thus sufficiently fixed by means of the adapter and resonance vibrations of the holding part, which overlap the structure-borne sound, are reduced.

The coupling part is preferably formed as a first screw with a first shaft section and a first head section. The holding part is further preferably formed as a second screw with a second shaft section and a second head section. The adapter is thereby preferably configured for being engaged, preferably in a releasable manner, with the first head section and the second head section. Alternatively or additionally, the coupling part has a coupling receptacle and the holding part and/or the adapter has a corresponding coupling section, wherein the coupling receptacle can be brought into engagement with the coupling section in a releasable manner. Standard components are thus provided for the holding part and the coupling part, so that manufacturing costs can be reduced. A coupling receptacle is introduced into the coupling part in a simple manner. Such a coupling receptacle can be implemented as internal thread or threaded bore, respectively, or also as external thread in a simple manner with regard to manufacturing technology. Further external contours, which can be brought into engagement with a corresponding adapter mounting interface, are likewise conceivable.

According to a preferred embodiment, the adapter has a receiving space, which is configured for receiving at least one section of the sensor. The received sensor is preferably a temperature sensor. Such a receiving space simplifies the arrangement of the sensor relative to the coupling assembly.

The sensor device preferably further has a sensor housing with coupling sections and the adapter has a corresponding housing interface, which is configured for the releasable coupling to the coupling sections. A higher level of functional integration with regard to the adapter is thus achieved. The housing interface is further preferably formed by means of a wall, which delimits the receiving space in the radial direction. The adapter is thus structurally simplified.

The adapter preferably extends along a or the longitudinal axis, respectively, with an adapter length and further has a sensor receptacle, which preferably extends along at least ¾ of the adapter length. The sensor receptacle thus extends in a region of the adapter, adjoining the coupling part. A more precise temperature detection of the temperature of the coupling part is thus possible.

According to a further preferred embodiment, the coupling part has a coupling receptacle, which is formed for receiving a coupling section of the holding part. The coupling receptacle can be, for example, a threaded bore, and the coupling section of the holding part can preferably be a corresponding external thread. A structure-borne sound-conducting connection of the coupling part and of the holding part can thus be realized in a simple manner.

The front conductor is preferably arranged adjacent to and spaced apart from the coupling part and/or the adapter, so that a hollow space, which forms the thermal insulator, is formed between the front conductor and the coupling assembly. Air or a gas, which reduces the heat transmission, can be located in the hollow space. Air thereby in particular represents a cost-efficient insulator.

The front conductor is further preferably formed as a sleeve and has a first external diameter adjacent to the first piezo element and a second external diameter adjacent to the coupling assembly, in particular the coupling part or the adapter, which is smaller than the first external diameter and which is configured for resting against a corresponding contact surface of the coupling part or of the adapter. The first external diameter is in particular at least twice as large as the second external diameter. The front conductor thus serves the purpose of biasing the piezo elements as well as of reducing the heat transfer. Due to the smaller second external diameter, the front conductor only has a small contact surface to the coupling part and simultaneously an enlarged contact surface to the ambient air. The ambient air cools the front conductor, while the heat transfer from the coupling part is limited by means of the small contact surface.

According to a particularly preferred embodiment, the sensor is a first sensor, and the sensor device further has at least one second sensor for detecting the temperature of the coupling assembly and/or of the housing, wherein the sensor device is configured for detecting a blockage of the flow path by detecting the temperature of the coupling assembly and/or housing by means of the second sensor. The temperature sensor thus provides for the detection of banking-up of condensate due to blockages of the flow path, which cause a temperature change. In particular water hammering can be reduced thereby. Thermal effects, which influence the measuring result of the first sensor, can thus further be detected by means of the second sensor and the measuring accuracy of the first sensor can thus be ensured.

The coupling assembly, preferably the coupling part and/or the holding part of the coupling assembly, further preferably has a sensor receptacle for the second sensor. The second sensor can thus be coupled to the coupling assembly in a simple manner by being received in the sensor receptacle, in order to detect the temperature of the coupling assembly. The detection of the temperature of the coupling assembly is thereby particularly preferred because the coupling assembly is configured for the connection to the housing of the control fitting and thus allows drawing conclusions to changed temperatures of the flow path within the housing.

According to a further preferred embodiment, the holding part, preferably the clamping part and/or the holding section of the holding part, has a sensor receptacle for the second sensor. The temperature sensor can thus be integrated into the holding part in a simple manner and so as to save space.

The coupling assembly, in particular the coupling part, preferably has a heat conductivity λ of less than

$$50 \frac{W}{m \cdot {k}^{1}} ,$$

preferably of less than

$$100 \frac{W}{m \cdot {k}^{1}} ,$$

particularly preferably on less than

$$15 \frac{W}{m \cdot k} .$$

The influence of the temperature of the housing or of the flow path, respectively, on the sensor is thus further reduced.

The coupling assembly, preferably the coupling part, further preferably has a ceramic material, preferably zirconium oxide. Zirconium oxide has a low heat conductivity of less than

$$15 \frac{W}{m \cdot k}$$

and is thus suitable for the thermal shielding of the sensor with respect to the flow path in the housing. Zirconium oxide additionally has a high hardness and a good corrosion resistance, so that the material is very well suited for control fittings.

The sensor device further preferably further comprises a sensor housing with coupling sections, wherein the coupling sections are configured for coupling to the coupling assembly and/or the housing. The sensor is thus reliably protected against environmental influences, such as in particular moisture and dirt.

According to a preferred embodiment, the sensor device has a sender, which is configured for transmitting a sensor signal of the first sensor and preferably of the second sensor to an evaluation unit assigned to the control fitting, in particular by means of a signal connection. The signal connection preferably takes place wirelessly, wherein the sensor device further has an energy storage. The sensor device preferably comprises an energy harvester, such as, e.g., thermogenerator. The evaluation unit, which is assigned to the control fitting or several control fittings, respectively, is preferably configured for evaluating the sensor signal of the first sensor and preferably of the second sensor, in order to monitor the operating state and to in particular detect a blockage and/or leakage.

The evaluation unit is further preferably configured for evaluating a plurality of first and second sensors of different sensor devices and, for this purpose, to detect a clogging based on these sensor signals. The evaluation unit can be a processor, which is arranged in a stationary or a mobile device and which preferably has a data storage.

The evaluation unit is preferably configured for comparing the sensor signals to reference data of the data storage and for identifying a leakage and/or blockage or partial clogging of the flow path, based on this comparison.

According to a preferred embodiment, the sensor device, in particular the sensor housing, has a signal connection for providing a sensor signal or several sensor signals, wherein the signal connection can be coupled to a sender and/or an evaluation unit. The sensor device thereby preferably comprises an energy harvester, such as, e.g., thermogenerator. When connecting an evaluation unit, a direct and self-sufficient signal processing is thus made possible. The evaluated sensor data is either provided to a central data storage, for example a cloud, by means of a sensor or a sender coupled to the sensor, respectively, or can optionally be connected to mobile devices, in order to display a warning message or an information with regard to the monitored operating state, respectively.

The coupling assembly preferably has a magnet, in particular permanent magnet, for coupling the sensor or the sensors, respectively, to the housing, wherein in particular the coupling part comprises a magnet. In terms of the invention, a magnet provides for a non-positive connection by means of magnetic forces in a simple manner. The mounting time as a whole is thus reduced and the handling of the sensor device is simplified.

In a third aspect, the present invention solves the above-mentioned object by means of a condensate drain with the features according to claim 15.

According to the third aspect of the invention, which is simultaneously a preferred exemplary embodiment of the first or second aspect of the invention, respectively, the coupling assembly comprises: a or the coupling part, respectively, which can be brought into engagement with a corresponding coupling interface of the housing in a releasable manner, a or the holding part, respectively, which is indirectly connected to the housing and so as to conduct structure-borne sound and which is configured for the at least indirect connection to the coupling part, and a sensor receptacle, which is assigned to the holding part and which is configured for receiving a second sensor for the detection of the temperature. The coupling part thus solely serves the purpose of being coupled to the housing and the holding part holds the first sensor and the second sensor in the sensor receptacle adjacent to and spaced apart from the coupling part. The first and second sensor are thus protected. In particular a disadvantageous influencing of the measuring results due to the high temperatures of the housing, which are conducted via the coupling part, is avoided.

Preferred embodiments of the control fitting according to the first and second aspect of the invention are likewise preferred embodiments with regard to the third aspect of the invention and reference is made to the above description of the advantages and possible designs associated therewith. It is to be understood thereby that the condensate drain according to the third aspect can also be a control fitting in general.

In a fourth aspect, the present invention solves the above-mentioned object by means of a sensor device with the features according to claim 17.

According to the fourth aspect, the invention relates to a sensor device for a control fitting for detecting a blockage and/or leakage of a flow path, in particular for a condensate drain according to the first aspect of the invention. The sensor device comprises: a coupling assembly for coupling to the housing and at least one sensor for detecting structure-borne sound and/or for detecting a temperature of the coupling assembly and/or of the housing. The invention solves the above-mentioned object according to the fourth aspect in that the sensor device is configured for the arrangement downstream from a closure element of the condensate drain and for detecting at least one of the following: a leakage of the condensate drain by detecting the structure-borne sound of the coupling assembly and/or of the housing, and a blockage of the flow path by detecting the temperature of the coupling assembly and/or of the housing.

Alternatively or additionally, the above-mentioned object with regard to the sensor device is solved in that the coupling assembly has a coupling part, which is configured for the releasable connection to the housing, and an adapter, which is configured for connecting the sensor to the coupling part so as to conduct structure-borne sound and/or temperature.

Alternatively or additionally, the above-mentioned object with regard to the sensor device is further solved in that the coupling assembly comprises: a coupling part, which can be brought into engagement with a corresponding coupling interface of the housing in a releasable manner, a holding part, which is connected indirectly to the housing and so as to conduct structure-borne sound and which is configured for the positive and/or non-positive connection to a first sensor and for the at least indirect connection to the coupling part, and a sensor receptacle, which is assigned to the holding part and which is configured for receiving a second sensor for detecting the temperature.

The sensor device according to the fourth aspect of the invention adopts the advantages described above with regard to the control fitting according to the first to third aspect of the invention by means of such a sensor device. Advantages and preferred embodiments according to the first to third aspect are likewise advantages and preferred embodiments according to the fourth aspect of the invention and vice versa.

It should be understood that the sensor device according to the invention can also be used to detect a blockage and/or leakage of the flow path of a pipe or of another fluid-conducting assembly group.

In a fifth aspect, the present invention solves the above-mentioned object by means of a method with the features according to claim 18.

By providing a sensor device according to the fourth aspect of the invention, the method according to the invention adopts the advantages described above with regard to the first, second and third aspect of the invention. Advantages and preferred embodiments according to the first, second and third aspect of the invention are likewise preferred embodiments and advantages with regard to the fifth aspect of the invention and vice versa.

The method preferably further comprises the steps of:
providing at least one second sensor signal by means of a temperature sensor,
sending the second sensor signal to the evaluation unit and
jointly evaluating the sensor signal of the first sensor and of the temperature sensor.

The invention will be described below with reference to the enclosed figures on the basis of preferred exemplary embodiments, in which:

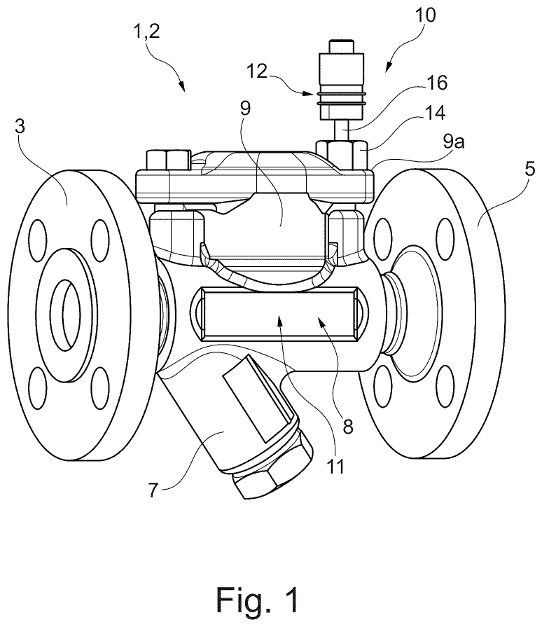

FIG. 1 shows a control fitting according to a first preferred embodiment in a perspective view;

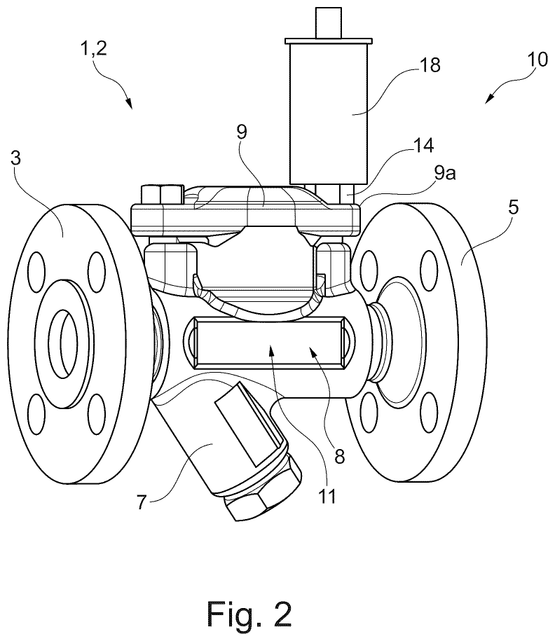

FIG. 2 shows a control fitting according to a second preferred embodiment in a perspective view;

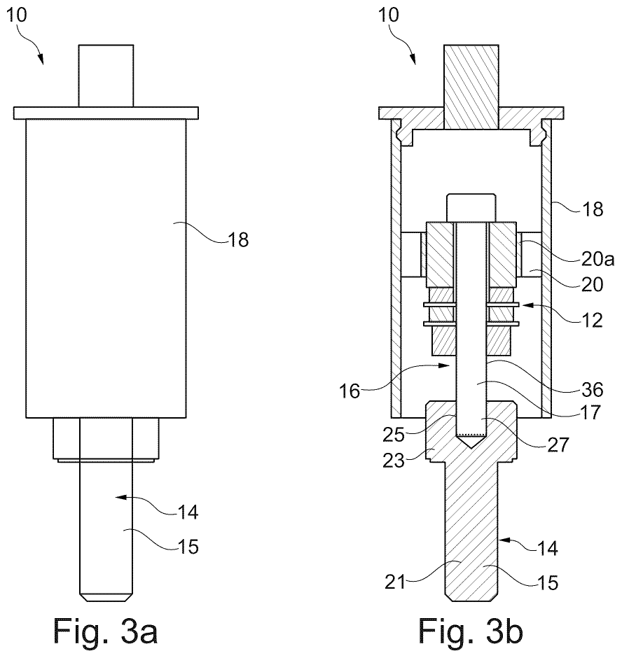

FIG. 3a shows a sensor device for a control fitting according to FIG. 2 in a side view;

FIG. 3b shows the sensor device according to FIG. 3a in a cut view;

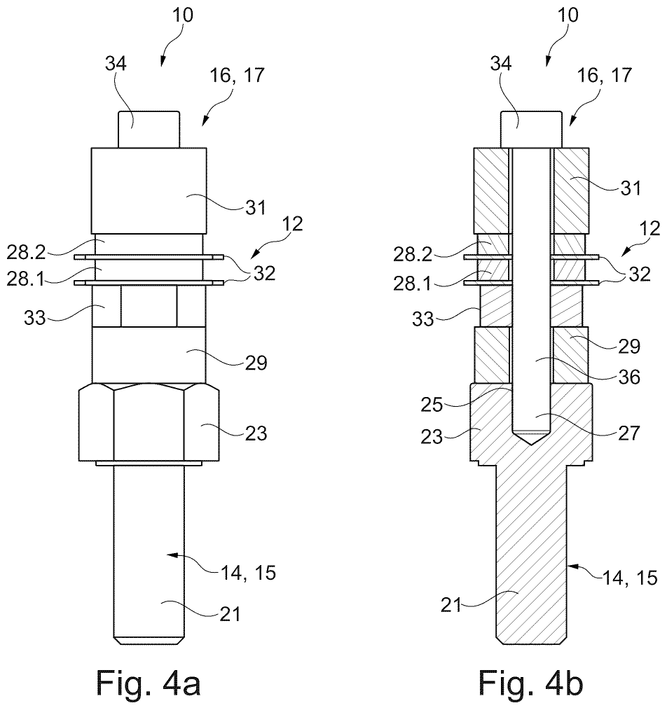

FIG. 4a shows an embodiment of a sensor device in a side view;

FIG. 4b shows the sensor device according to FIG. 4a in a sectional view;

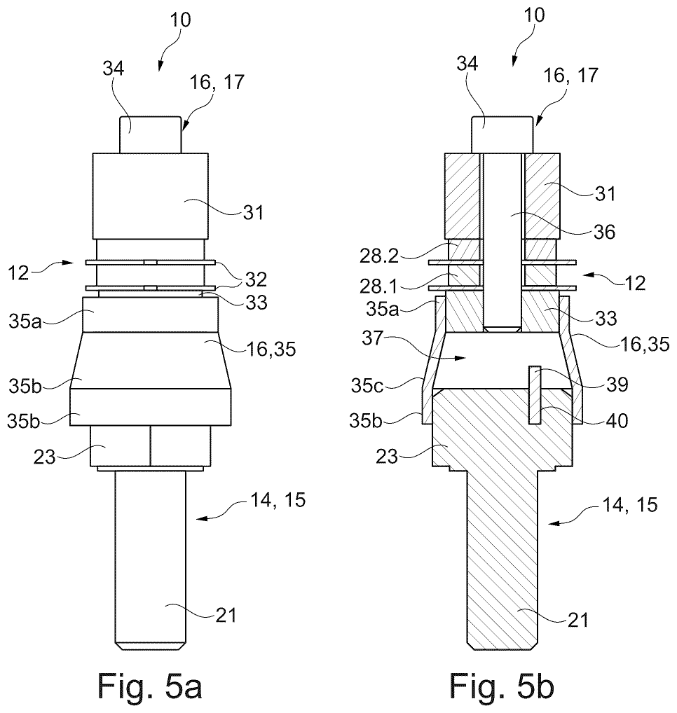

FIG. 5a shows a further embodiment of a sensor device in a side view;

FIG. 5b shows the sensor device according to FIG. 5a in a sectional view;

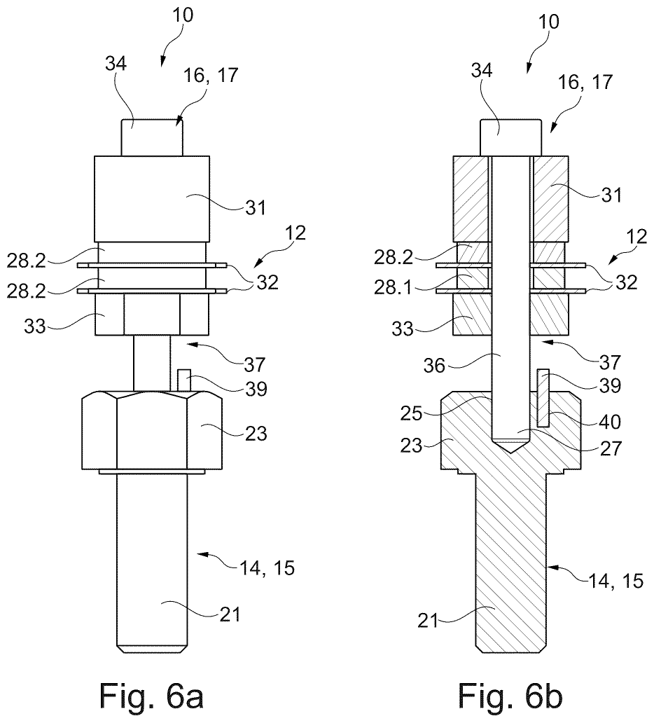

FIG. 6a shows a further embodiment of a sensor device;

FIG. 6b shows a sectional view of the sensor device according to FIG. 6a;

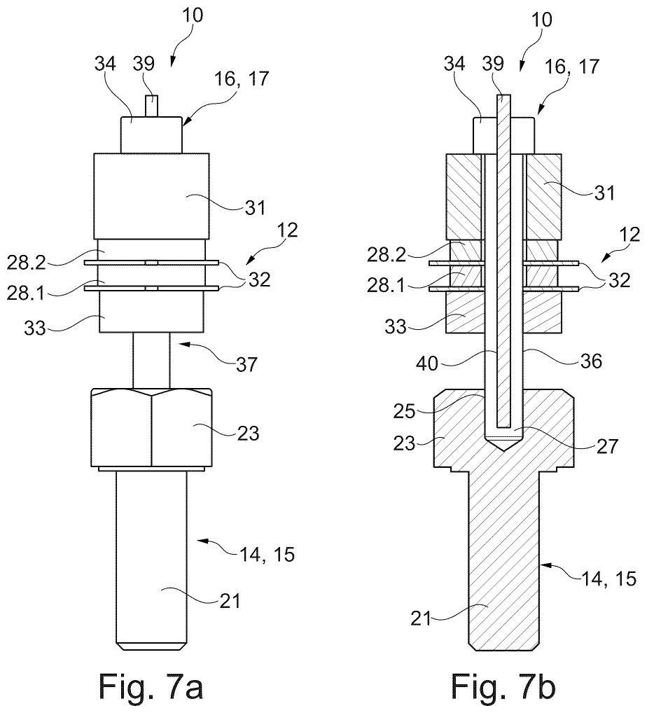

FIG. 7a shows a further embodiment of a sensor device in a side view;

FIG. 7b shows the sensor device according to FIG. 7a in a sectional view;

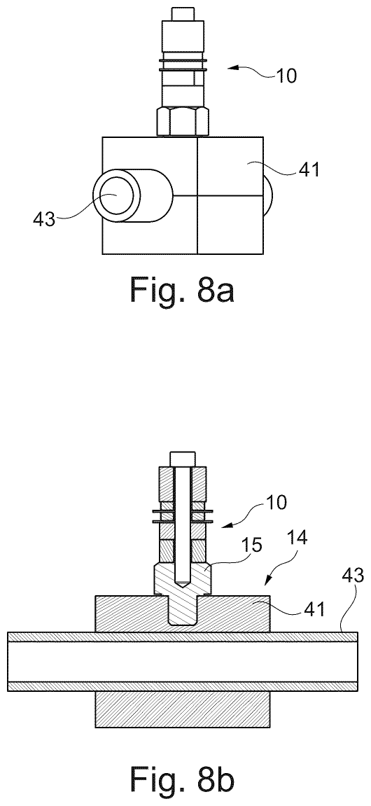

FIG. 8a shows a further embodiment of a sensor device in a side view;

FIG. 8b shows the sensor device according to FIG. 8a in a sectional view;

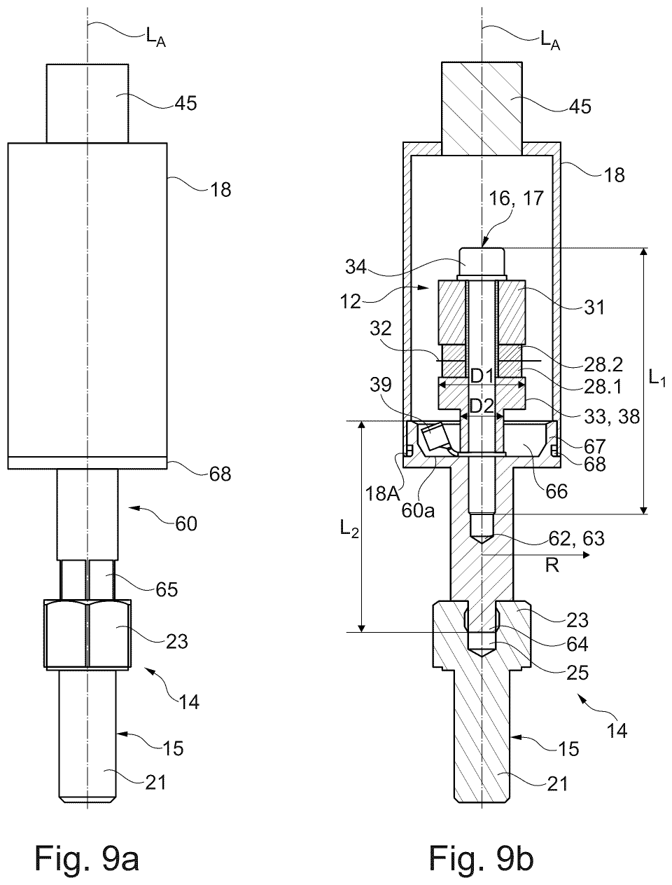

FIG. 9a shows a further embodiment of a sensor device in a side view;

FIG. 9b shows the sensor device according to FIG. 9a in a sectional view;

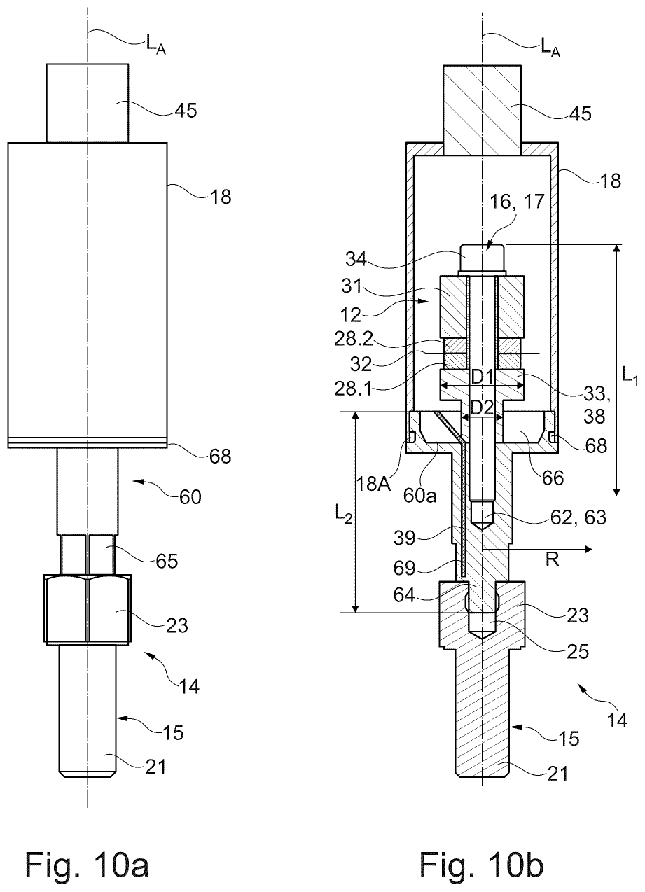

FIG. 10a shows a further embodiment of a sensor device in a side view;

FIG. 10b shows the sensor device according to FIG. 10a in a sectional view; and

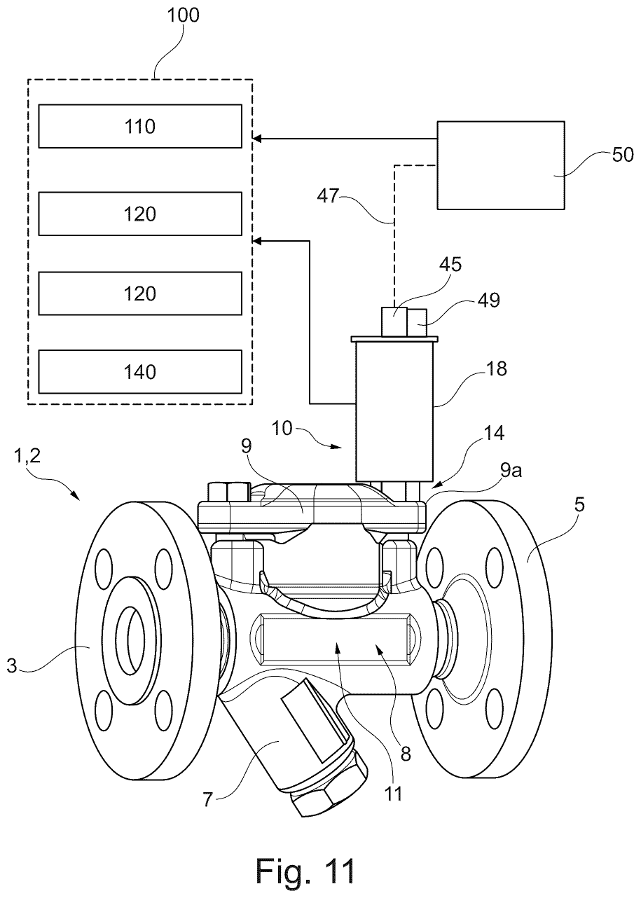

FIG. 11 schematically shows a method for detecting a blockage and/or leakage of a flow path for a control fitting according to FIG. 2.

FIG. 1 shows a control fitting 1, which is formed as condensate drain 2. The condensate drain 2 comprises an inlet flange 3 and an outlet flange 5, which can be connected to a pipe system (not shown). The respective fluid comprising gaseous components and condensate can enter through the inlet flange 3 into the condensate drain 2, which then drains condensate via the outlet flange 5.

The condensate drain 2 further comprises a condensate deflection with a protective screen 7 and a flow path 8, which is formed in a housing 9 and which extends between the inlet flange 3 and the outlet flange 5. A sensor device 10 is connected to the housing 9 so as to conduct structure-borne sound.

A non-illustrated closure element 11, which is configured for selectively releasing the flow path 8, is arranged in the flow path 8 within the housing 9. This is in particular a bimetal or a membrane, which releases the flow path 8 as a function of temperature, so that condensate can be drained by means of the condensate drain 2.

The sensor device 10 comprises a sensor 12 and coupling assembly 14 for connecting the sensor device 10 to the housing 9 and in particular to a coupling interface 9a of the housing 9. The coupling assembly 14 is connected in a positive and/or non-positive manner to the sensor 12 and is configured for establishing a releasable, positive and/or non-positive connection to the housing 9 or the coupling interface 9a, respectively, in order to conduct the structure-borne sound of the housing 9 to the sensor 12 in the mounted state.

The coupling assembly 14 further comprises a coupling part 15 and a holding part 16, which can be connected to the coupling part 15 in a releasable manner, wherein the sensor 12 is connected to the housing 9 by means of the coupling assembly 14 so as to conduct structure-borne sound. A structure-borne sound-conducting connection is thus formed between the sensor 12 and the housing 9, which makes it possible for the sensor 12 to detect the structure-borne sound of the housing 9 and to thus allow drawing conclusions to the operating state and in particular to blockages and/or leakages in the flow path 8. The combination of the coupling part 15 and of the holding part 16 thereby provides for a division of functions, whereby the structure-borne sound to be detected propagates within the coupling part 15 and the holding part 16.

The sensor device 10 can also be coupled to the housing 9 at any other position, it is preferably arranged downstream from the closure element 11, however.

The sensor device 10 according to a first embodiment was shown in FIG. 1 The control fitting 1 according to FIG. 2, which is likewise formed as condensate drain 2, differs from the condensate drain 2 shown beforehand in FIG. 1 by the sensor device 10, which is shown in a second preferred embodiment in FIG. 2. Identical reference numerals were used for identical or similar components, respectively, and reference is made to the above description of the exemplary embodiment shown in FIG. 1.

The sensor device 10 comprises a sensor housing 18, which is coupled to the coupling assembly 14 and which receives the first sensor 12 (see FIG. 3a, 3b) as well as the holding part 16 (see FIG. 3a, 3b). The holding part 16 as well as the sensor 12 are thus received securely within the sensor housing 18 and are protected against environmental influences. The sensor housing 18 is preferably coupled to the holding part 16 and/or the sensor 12 and/or the coupling part 15 in a reversible manner.

FIGS. 3a and 3b show the sensor device 10 according to FIG. 2 in detail.

The coupling assembly 14 comprises a coupling part 15 formed as connecting screw for coupling to a coupling interface 9a of the housing 9 (see FIG. 1), wherein the sensor housing 18 is arranged adjacent to the coupling part 15. As shown in particular in FIG. 3b, the coupling assembly 14 comprises a holding part 16, which is formed as a screw 17 with a holding section 36.

The coupling part 15 formed as connecting screw comprises a shaft section 21 and a head section 23. A coupling receptacle 25, in which a coupling section 27 is received, which is formed as distal end of the holding part 16, is formed in the head section 23.

The sensor 12 is a piezoelectric sensor, which comprises a first piezo element 28.1 and a second piezo element 28.2, which are formed as plate with a cylindrical bore in the centre in the present case. The sensor 12 further comprises a pair of electrodes 32 for providing an electrical signal or a current, respectively. The holding part 16 formed as screw 17 is guided through the bore.

The sensor 12 comprises a front conductor 33. The holding part 16 comprises a clamping part 34, which is formed by means of a head section of the screw 17. The front conductor 33 is formed as disk, which has a central bore with an internal thread and which engages with the holding section 36 of the holding part 16, which is formed as screw 17.

Sensor 12 further comprises a seismic mass 31, which is arranged adjacent to the clamping part 34 and which is formed as plate with a cylindrical bore in the centre in the present case. The screw 17 is guided through the bore. The clamping part 34 rests at least temporarily against the seismic mass 31. The sensor 12, comprising at least one first piezo element 28.1 and a second piezo element 28.2, can thus be arranged and fixed securely between the front conductor 33 and the clamping part 34, wherein the seismic mass 31 engages with the screw 17 and in particular the holding section 36 so as to be movable relative to the first piezo element 28.1 and the second piezo element 28.2.

The front conductor is arranged spaced apart from and adjacent to the coupling assembly 14, in particular the head section 23 of the coupling part 15. A hollow space 37, which forms the thermal insulator, is thus formed between the front conductor 33 and the head section 23 of the coupling part 15. In the present case, the hollow space 37 describes the space, which extends around the holding section 36 in the radial direction and which is delimited in particular by means of the radial extension of the head section 23 and of the front conductor 33. The thermal insulation of the sensor 12 is increased by the coupling assembly 14 and thus the housing 9 (see FIGS. 1 and 2) by means of the hollow space 37.

In the shown embodiment, the seismic mass 31 is connected to the sensor housing 18 via a coupling section 20 of the housing 18. A non-positive and/or frictional as well structure-borne sound-conducting connection is preferably formed between the seismic mass 31 and the coupling section 20. The coupling section 20 preferably has a contact surface 20a facing the seismic mass 31 with a friction-promoting surface coating, in particular a polymer coating. The contact surface 20a of the coupling section 20 is preferably rubberized.

A further exemplary embodiment of the sensor device 10 according to the invention is shown in FIGS. 4a and 4b. Identical reference numerals were used for identical or similar components, respectively, and reference is made to the above description of the exemplary embodiment shown in FIGS. 3a and 3b. On the one hand, the shown embodiment differs from the exemplary shown beforehand in FIGS. 3a and 3b in that the sensor device 10 does not have a sensor housing 18 (see FIGS. 3a and 3b). This sensor housing 18 can optionally be supplemented in the case of the exemplary embodiment shown in FIGS. 4a and 4b.

The exemplary embodiment shown in FIGS. 4a and 4b further differs from the above exemplary embodiment by a thermal insulator made of a solid insulation material 29, which is arranged between the front conductor 33 and the head section 23 of the coupling assembly 14. The thermal insulator made of a solid insulation material 29 has a central bore for the guide-through of the holding section 36. The thermal insulator made of a solid insulation material 29 is thereby formed by means of the coupling section 27, which is received in the coupling receptacle 25, of the holding part 16 formed as screw 17. A further processing of the thermal insulator made of a solid insulation material 29 for forming a non-positive connection between the thermal insulator made of a solid insulation material 29 and the screw 17, for example by means of a screw-connection, can thus be forgone.

FIGS. 5a and 5b show a further exemplary embodiment of the sensor device 10 according to the invention. Identical reference numerals were used for identical or similar components, respectively, and reference is made to the above description of the exemplary embodiments shown in FIG. 3a and FIG. 3b as well as 4a and 4b.

The sensor device 10 comprises a sensor 12 in the known manner, which, in the present case, is a first sensor, a coupling assembly 14 with a coupling part 15 and a holding part 16, which is coupled to the coupling part 15 in a releasable manner. The holding part 16 is formed as screw 17 and has a holding section 36 and a clamping part 34. The holding section 36 engages with the front conductor 33, wherein the head section of the screw 17 forms a clamping part 34. The coupling assembly 14 further has a connecting part 35, which is a sleeve in the present case, for coupling the coupling part 15 and the holding part 16 in a releasable manner.

The sleeve 35 preferably comprises a first cylindrical section 35a, by means of which the sleeve 35 rests against an external circumference of the front conductor 33, and a second cylindrical section 35b, by means of which the sleeve 35 rests against the head section 23 of the coupling part 15, which is formed as connecting screw in the present case. The sleeve 35 further comprises a transition region 35c, which tapers from the second cylindrical region 35b to the first cylindrical region 35a. The sleeve 35 is preferably coupled in a non-positive manner to the front conductor 33 and the head section 23 of the connecting screw 15. The sleeve 35 is formed to establish a structure-borne sound-conducting connection between the coupling assembly 14 and in particular the head section 23 as well as the holding part 16 and in particular the seismic mass 31. In the present case, the structure-borne sound-conducting connection to the seismic mass 31 takes place indirectly by means of the front conductor 33 and the holding part 16. The sensor 12 is formed as piezoelectric sensor in the known manner and preferably comprises a first piezo element 28.1 and a second piezo element 28.2. The sensor 12 further comprises a pair of electrodes 32 for providing an electrical signal or a current, respectively. The structure-borne sound is thus transferred via the sleeve 35 and the holding part 16 to the first piezo element 28.1 and the second piezo element 28.2.

The hollow space 37 is further formed between the head section 23 and the front conductor 33. The hollow space 37 is delimited in the radial direction by means of the sleeve 35 and in the axial direction by means of the head section 23 and the front conductor 33. An insulation of the holding part 16 and in particular of the front conductor 13 with respect to the coupling part 15 or the housing 9, respectively (see FIG. 1) is thus ensured by means of the hollow space 37. By avoiding the engagement of the holding section 36 and of the coupling part 15, the heat conduction is further reduced and the sensor 12 is protected against the high temperatures of the housing 9 (see FIGS. 1 and 2).

In addition to the first sensor 12, which is formed as piezoelectric sensor with the first piezo element 28.1 and the second piezo element 28.2, the sensor device 10 further comprises a second sensor 39 for detecting the temperature of the coupling assembly 14. The second sensor 39 is thus formed as temperature sensor. The temperature sensor 39 is received in a sensor receptacle 40, which is preferably formed in the head section 23 of the coupling part 15.

The exemplary embodiment of the sensor device 10 according to the invention shown in FIGS. 6a and 6b differs from the exemplary embodiment shown beforehand in FIGS. 3a and 3b in that, in addition to the first sensor 12, a second sensor 39 is further provided. Identical reference numerals were used for identical or similar components, respectively, and reference is made to the above description of the exemplary embodiment shown in FIG. 3a and FIG. 3b.

The first sensor 12 is formed as piezoelectric sensor in the known manner and comprises a first piezo element 28.1 and a second piezo element 28.2. The sensor 12 further comprises a pair of electrodes 32 for providing an electrical signal or a current, respectively. The second sensor 39 is a temperature sensor, which is received in a sensor receptacle 40. The second sensor 39 is configured for indicating a blockage of the flow path 8 by detecting a temperature change. In the shown embodiment, the sensor receptacle 40 is formed in the head section 23 of the coupling part 15. Alternatively, the sensor receptacle can also be arranged in the holding part 16.

The exemplary embodiment shown in FIGS. 7a and 7b differs from the exemplary embodiment shown above in FIGS. 6a and 6b or 3a and 3b, respectively, in that, in addition to the first sensor 12, the sensor device 10 has a second sensor 39, which is preferably formed as temperature sensor. Identical reference numerals were used for identical or similar components, respectively, and reference is made to the above description of the exemplary embodiments shown in FIGS. 6a and 6b or FIG. 3a and FIG. 3b, respectively.

In the known manner, the first sensor 12 is preferably a piezoelectric sensor with a first piezo element 28.1 and a second piezo element 28.2. The sensor 12 further comprises a pair of electrodes 32 for providing an electrical signal or a current, respectively, which changes as a function of the structure-borne sound in the housing 9 (see FIG. 1).

The second sensor 39 is received in a sensor receptacle 40. The sensor receptacle 40 is formed in the holding part 16. The second sensor 39 is formed for detecting the temperature of the holding part 16, in order to detect a blockage in the condensate drain 2. The holding part 16 is thereby formed as screw 17 with a head section, which forms a clamping part 34 and a holding section 36, wherein the sensor receptacle 40 extends from the clamping part 34 through the holding section 36 all the way to the coupling section 27, which engages in the known manner with a corresponding coupling receptacle 25 of the coupling part 15. In addition to the detection of the temperature of the holding part 16, a rapid detection of temperature differences of the coupling part 15 and of the housing 9 (see FIG. and 2) is possible by means of the extension of the second sensor 39 into the coupling section 27. The second sensor 39 thus indirectly also detects temperature fluctuations of the coupling part 15 by means of the reception of the coupling section 27 in the head section 23 at least in sections.

FIGS. 8a and 8b show a further exemplary embodiment of the sensor device 10 according to the invention. The shown exemplary embodiment differs from the exemplary embodiment shown above in FIGS. 4a and 4b in that the control fitting is a pipe section 43 and by means of the formation of the coupling assembly 14. Identical reference numerals were used for identical or similar components, respectively, and reference is made to the above description of the exemplary embodiment shown in FIG. 4a and FIG. 4b.

The coupling assembly 14 is formed in two pieces and comprises a coupling part 15, which is formed as connecting screw, and a holding part 41, which is formed as pipe clamp. The coupling part 15 engages with a receptacle, preferably a threaded bore 42 of the pipe clamp 41 in a releasable manner, so that a structure-borne sound-conducting connection is ensured between the second holding part formed as pipe clamp 41 and the coupling part formed as connecting screw 15. By means of the coupling assembly 14, the sensor device 10 is configured in the known manner to establish a structure-borne sound-conducting connection to a control fitting and in particular a pipe section 43. Leakages within the pipe section 43 or the control fitting can thus be detected reliably on the basis of the change of the structure-borne sound by means of the sensor device 10. It should be understood that in the shown exemplary embodiment, the sensor device 10 is configured for the structure-borne sound-conducting connection to any pipeline of a pipeline system, in order to monitor the operating state and to detect a leakage.

According to the invention, a corresponding formation of the coupling assembly 14 can be combined with all of the embodiment variations shown in FIGS. 2a to 7b, so that the temperature of the coupling assembly 14 is monitored, for example by means of a second sensor, in order to detect a blockage of the flow path of the pipe section 43.

FIG. 9a and FIG. 9b show a further embodiment of the sensor device 10. In the known manner, the sensor device 10 comprises a coupling assembly 14 for coupling to the housing 9 (see FIG. 1). The sensor device 10 further comprises a first sensor 12 for detecting structure-borne sound and a second sensor 39 for detecting the temperature of the coupling assembly 14 and/or of the housing 9 (see FIG. 1). The coupling assembly 14 is connected in a positive manner to the first sensor 12 and is configured for establishing a releasable, positive connection to the housing 9 (see FIG. 1), in order to conduct the structure-borne sound of the housing 9 to the sensor 12 in the mounted state. In the present case, the sensor 12 is a piezoelectric sensor, wherein reference is made to the description of the preceding exemplary embodiments.

In the known manner, the coupling assembly 14 comprises a coupling part 15, which can be brought into releasable engagement with the corresponding coupling interface 9a (see FIG. 1) of the housing 9. The coupling assembly 14 furthermore comprises a holding part 16, which is connected indirectly and so as to conduct structure-borne sound to the housing 9 and which engages in a positive manner with the first sensor 12 in the present case.

The coupling part 15 is formed as a first screw 15 with a first shaft section 21 and a first head section 23. The holding part 16 is formed as a second screw 17 with a second head section 34 and a second shaft section 36. The second head section 34 simultaneously forms a clamping part for pretensioning the first sensor 12 and the second shaft section 36 forms a holding section, which is configured for engaging with an adapter 60 of the coupling assembly 14.

The adapter 60 comprises a mounting interface 62, which is formed as threaded bore 63. The second shaft section 36 formed as holding section is configured for engaging with the threaded bore 63. The threaded bore 63 extends along a longitudinal axis L_{A} and preferably runs coaxially to the coupling receptacle 25 of the coupling part 15.

The holding part 16 has a first length L1 in the direction of the longitudinal axis L_{A}. The adapter mounting interface 62, in particular the threaded bore 63, thereby has at least ⅓ of the length L1 of the holding part 16. The threaded bore 63 of the adapter 60 is thus configured for engaging with the holding part 16 along at least ⅓ of the length L1 thereof. A sufficient force transmission between holding part 16 and adapter 60 is thus ensured.

The adapter 60 has a contact surface 60a, which extends in a radial direction R. The front conductor 33 of the first sensor 12 is thereby formed as sleeve 38 with a first diameter D1, which adjoins the first piezo element 28.1, and a second diameter D2, which adjoins the contact surface 60a. The first diameter D1 and the second diameter D2 thereby in each case refer to the external diameters of the sleeve 38. The diameter D2 is thereby greater than the diameter of the threaded bore 63, so that the front conductor 33 rests against the contact surface 60a, wherein the holding part 16 formed as second screw 17 is in threaded engagement with the threaded bore 63 with the holding section 36. The first and the second piezo element 28.1, 28.2 are thereby clamped firmly between the screw head 34 and the front conductor 33.

The adapter 60 further has a coupling section 64, which is configured for engaging with the coupling receptacle 25 of the coupling part 15. The coupling section 64 is preferably formed to come into engagement with the coupling receptacle 25 by means of a screwing movement, wherein the coupling section 64 deforms plastically. A solid connection is thus created between the adapter 60 and the coupling part 15.

As in particular shown in FIG. 9a, the adapter 60 has a tool attachment 65, which is configured for engaging with a corresponding tool in such a way that the adapter 60 comes into engagement with the coupling receptacle 25 for engaging the coupling section 64 with the coupling receptacle 25 by means of a rotation about the longitudinal axis L_{A}.

The adapter 60 further has a receiving space 66, which is formed by means of the contact surface 60a extending in the radial direction R and a wall 67 surrounding said contact surface in the radial direction R. This receiving space 66 is preferably configured for receiving the second sensor 39 at least in sections.

A housing interface 68, which is configured for engaging with a corresponding mounting interface 18A of the sensor housing 18, is further formed on the outer circumferential surface of the wall 67.

An upper section of the second sensor 39 extends into the receiving space 66 and is thus surrounded by the sensor housing 18. The second sensor 39 is thus protected and can be connected to a sender 45 within the sensor housing 18.

FIGS. 10a and 10b show a further embodiment of the sensor device 10 according to the invention. Reference is made to the description of the exemplary embodiment shown in FIGS. 9a and 9b, whereby identical or similar components, respectively, have identical reference numerals. To avoid repetitions, reference will only be made to differences of the two embodiments.

The adapter 60 extends along the longitudinal axis L_{A} with an adapter length L2. In the exemplary embodiment shown in FIGS. 10a and 10b, the adapter 60 has a sensor receptacle 69, which preferably extends along at least ¾ of the adapter length L2. The sensor receptacle 69 thereby thus extends all the way to a region adjoining the head section 23 of the coupling part 15. The sensor receptacle 69 is thereby configured for receiving a second sensor 39, which is formed as temperature sensor in the present case.

In the present case, the sensor device 10 also has a sender 45, which is configured for transmitting a sensor signal of the first sensor 12 and/or of the second sensor 39 to an evaluation unit 50 (see FIG. 11) assigned to the condensate drain 2 by means of a signal connection 47 (see FIG. 11).

FIG. 11 shows a control fitting 1 according to the invention, which is formed as condensate drain 2. In the known manner, the condensate drain 2 comprises an inlet flange 3, an outlet flange 5, a condensate deflection with a protective screen 7 as well as a flow path 8 for fluids, which is formed between the inlet flange 3 and the outlet flange 5 and which extends in a housing 9.

A closure element 11, which is not shown in more detail, which is configured for selectively blocking or releasing the flow path 8, respectively, is arranged in the flow path 8 within the housing.

The sensor device 10 comprises a sensor 12 and a coupling assembly 14 for connecting the sensor device 10 to the housing 9 and in particular to a coupling interface 9a of the housing 9. The coupling assembly 14 is connected in a positive and/or non-positive manner to the sensor 12 and is configured for establishing a releasable, positive and/or non-positive connection to the housing 9 or the coupling interface 9a, respectively, in order to conduct the structure-borne sound of the housing 9 to the sensor 12 in the mounted state.

A sensor device 10 is connected to the housing 9 so as to conduct structure-borne sound (see FIGS. 2a to 10b). The sensor device 10 comprises a sensor housing 18. A sender 45, which is connected to the first sensor 12 and preferably an available second sensor 39 in a signal-conducting manner, is formed on the sensor housing 18. The second sensor 39 can be formed for the detection in front of a temperature and can be connected to the housing 9 in a heat-conducting manner in the above-described manner.

In all of the exemplary embodiments of the sensor device 10 shown in FIGS. 2a to 10b, a cable-routing connection (not shown) can alternatively also be provided instead of a sender 45 for the signal transmission. A plug or a bushing, respectively, for a sender or an evaluation unit, respectively, can alternatively also be formed on the sensor housing 18 (not shown).

The sender 45 is configured for transmitting sensor signals to an evaluation unit 50 by means of a signal connection 47, which is wireless in the present case. The evaluation unit 50 is assigned to the respective control fitting 1. An energy storage 49 is provided for the energy supply of the sender 45 and preferably of one or both of the sensors 12, 39. According to the invention, an electrical line to a supplier can also be provided instead of an energy storage 49, for a self-sufficient operation of the sensor device 10, an electrical line to a supplier.

In an alternatively preferred manner, the evaluation unit 50 can be an evaluation unit for controlling a plant, to which the control fitting 1 is assigned. Alternatively, the evaluation unit 50 can be an evaluation unit of the respective control fitting 1. Said evaluation unit can preferably be arranged spaced apart from the control fitting 1 or can be assigned to the housing 9 of the control fitting 1.

According to preferred exemplary embodiments, which are not shown in detail in the present case, alarm means can further be provided on the housing 9, which are configured for providing an alarm signal, which is optical and/or acoustic, as a function of the sensor signals evaluated by the evaluation unit 50 and the detection of a blockage and/or leakage.

A blockage and/or leakage in the flow path 8 can in particular be determined during the operation by means of a method for detecting a blockage, which comprises the steps of:
providing a sensor device 10,
structure-borne sound-conducting connection of the sensor device 10 to a housing 9 by means of a coupling assembly 14,
conducting the structure-borne sound by means of the coupling assembly 14 to at least one sensor 12, 39 (not shown, see FIGS. 3a to 8b),
   and further the following steps, which are performed by means of the first sensor 12 and the evaluation unit 50:
detecting 110 structure-borne sound in step S1 by means of the first sensor 12,
providing 120 at least one sensor signal in step S2 by means of the first sensor 12,
sending 130 the sensor signal in step S3 to an evaluation unit 50 by means of a sender 45, and
evaluating 140 the sensor signal of the first sensor 12 in step S4 by means of the evaluation unit 50.

It is preferred thereby that a sensor signal of the second sensor 39, which is a temperature signal, is further provided in step S2 and that this sensor signal is evaluated in step S4 together with the sensor signal of the first sensor 12, in order to monitor the operating state and to in particular detect a blockage and/or leakage.

### LIST OF REFERENCE NUMERALS

1 control fitting
2 condensate drain
3 inlet flange
5 outlet flange
7 condensate deflection with a protective screen
8 flow path
9 housing
9a coupling interface
10 sensor device
11 closure element
12 first sensor, piezoelectric sensor
14 coupling assembly
15 coupling part, first screw
16 holding part
17 second screw
18 sensor housing
20 coupling section
20a contact surface
21 first shaft section
23 first head section
25 coupling receptacle
27 coupling section
28.1 first piezo element
28.2 second piezo element
29 thermal insulator made of a solid insulation material
31 seismic mass
32 electrode
33 front conductor
34 clamping part, second head section
35 connecting part, sleeve
35a first cylindrical section
35b second cylindrical section
35c central section
36 holding section, second shaft section
37 hollow space
38 sleeve
39 temperature sensor
40 sensor receptacle
41 holding part, pipe clamp
42 threaded bore
43 pipe section
45 sender
47 signal connection
49 energy storage
50 evaluation unit
60 adapter
60a contact surface
62 mounting interface
63 threaded bore
64 coupling section
65 tool attachment
66 receiving space
67 wall
68 housing interface
69 sensor receptacle
A_{L} longitudinal axis
L1 first length
L2 second length
R radial direction
D1 first outer diameter
D2 second outer diameter
100 method
110 S1
120 S2
130 S3
140 S4

1. A condensate drain for controlling the flow-through of fluids, in particular the condensate drain for discharging liquid condensate, with
a housing with an inlet flange and an outlet flange,
a flow path formed between the inlet flange and the outlet flange,
a closure element, which is arranged in the flow path and which is configured for selectively blocking or releasing the flow path, respectively, and
a sensor device fastened to the housing for monitoring the operating state of the condensate drain,
wherein the sensor device has a coupling assembly for coupling to the housing as well as a sensor for detecting structure-borne sound and/or for detecting a temperature of the coupling assembly and/or of the housing,
wherein the sensor device is arranged downstream from the closure element and is configured to detect at least one of the following:
a leakage of the condensate drain by detecting the structure-borne sound of the coupling assembly and/or of the housing,
a blockage of the flow path by detecting the temperature of the coupling assembly and/or of the housing.

2. The condensate drain according to claim 1,
wherein the coupling assembly is connected in a positive and/or non-positive manner to the sensor and is configured for establishing a releasable, positive and/or non-positive connection to the housing, in order to conduct the structure-borne sound and/or the temperature of the housing to the sensor in the mounted state.

3. The condensate drain according to claim 1,
wherein the coupling assembly has a coupling part, which can be brought into engagement with a corresponding coupling interface of the housing in a releasable manner.

4. The condensate drain according to claim 3,
wherein the coupling assembly has a holding part, which is connected indirectly to the housing and so as to conduct structure-borne sound and which is configured for the positive and/or non-positive connection to the sensor and for the at least indirect connection to the coupling part.

5. The condensate drain according to claim 1,
wherein the coupling assembly has the coupling part, respectively, which is configured for the releasable connection to the housing, and an adapter, which is configured for connecting the sensor to the coupling part so as to conduct structure-borne sound and/or in a temperature-conductive manner.

6. The condensate drain according to claim 5,
wherein the coupling assembly further has a holding part, respectively, which is coupled to the sensor, and the adapter is configured for the positive and/or non-positive connection to the holding part.

7. The condensate drain according to claim 6,
wherein the coupling part and the holding part have a metallic material and the adapter is formed from a non-metallic material, in particular a technical ceramic and/or a polymer.

8. The condensate drain according to claim 6,
wherein the holding part extends along a longitudinal axis with a length and the adapter has an adapter mounting interface, in particular a threaded bore or an external thread, which is configured for engaging with the holding part along at least ⅓ of the length of the holding part.

9. The condensate drain according to claim 5,
wherein the coupling part is formed as a first screw with a first shaft section and a first head section, and/or
the holding part is formed as a second screw with a second shaft section and a second head section,
wherein the adapter is configured for being engaged, preferably in a releasable manner, with the first head section and the second shaft section, and/or
the coupling part has a coupling receptacle and the holding part and/or the adapter has a corresponding coupling section, wherein the coupling receptacle can be brought into engagement with the coupling section in a releasable manner.

10. The condensate drain according to claim 5,
wherein the adapter has a receiving space, which is configured for receiving at least one section of the sensor, and/or
the sensor device further has a sensor housing with coupling sections and the adapter has a corresponding housing interface, which is configured for the releasable coupling to the coupling sections,
wherein the housing interface is preferably formed by means of a wall, which
delimits the receiving space in the radial direction.

11. The condensate drain according to claim 5,
wherein the adapter extends along the longitudinal axis, respectively, with an adapter length and has a sensor receptacle, which preferably extends along at least ¾ of the adapter length.

12. The condensate drain according to claim 1,
wherein the sensor is a piezoelectric sensor, comprising:
at least one first piezo element and a second piezo element,
a pair of electrodes,
a seismic mass, which is configured for moving relative to the first piezo element and/or the second piezo element as a function of the structure-borne sound transmitted by the housing, and
a front conductor, which is spaced apart from the seismic mass and which is coupled to the coupling assembly and which is configured for arranging the first piezo element and the second piezo element relative to the seismic mass,
wherein the holding part is preferably configured for the positive and/or non-positive connection of the seismic mass and of the front conductor in such a way that the first piezo element and the second piezo element are received between the seismic mass and the front conductor, and the seismic mass engages with the holding part in a movable manner, wherein the holding part is configured, by conducting the structure-borne sound from the housing, to stimulate a mechanical vibration of the seismic mass, so that the seismic mass vibrates relative to the first piezo element and/or the second piezo element.

13. The condensate drain according to claim 12,
wherein the front conductor is arranged adjacent to and spaced apart from the coupling part the adapter, so that a hollow space, which forms the thermal insulator, is formed between the front conductor and the coupling assembly, or
the front conductor is formed as a sleeve and has a first external diameter adjacent to the first piezo element and a second external diameter adjacent to the coupling assembly, in particular the coupling part or the adapter, which is smaller than the first external diameter and which is configured for resting against a corresponding contact surface of the coupling part or against a corresponding contact surface of the adapter, and/or
the coupling assembly has a thermal insulator, which is configured for reducing the heat transmission from the housing to the sensor.

14. The condensate drain according to claim 1,
wherein the sensor is a first sensor, and the sensor device further has at least one second sensor for detecting the temperature of the coupling assembly and/or of the housing, and
the sensor device is configured for detecting a blockage of the flow path by detecting the temperature of the coupling assembly and/or of the housing by means of the second sensor, and/or
the coupling assembly has a sensor receptacle for the sensor, in particular
the second sensor.

15. The condensate drain according to claim 1,
wherein the coupling assembly comprises:
the coupling part, respectively, which can be brought into engagement with the corresponding coupling interface of the housing in a releasable manner,
the holding part, respectively, which is indirectly connected to the housing and so as to conduct structure-borne sound and which is configured for the at least indirect connection to the coupling part, and
a sensor receptacle, which is assigned to the holding part and which is configured for receiving a second sensor for the detection of the temperature.

16. The condensate drain according to claim 1,
wherein the sensor device has a sender, which is configured for transmitting a sensor signal of the sensor by means of a signal connection to an evaluation unit assigned to the condensate drain, wherein the evaluation unit is configured for evaluating the sensor signal of the sensor, in order to monitor the operating state and to in particular detect a blockage and/or leakage,
wherein the signal connection preferably is a wireless signal connection and the sensor device further has an energy storage.

17. The sensor device for monitoring the operating state of a control fitting, in particular of the condensate drain according to claim 1, comprising:
the coupling assembly for coupling to the housing, and
the sensor for detecting structure-borne sound and/or for detecting a temperature of the coupling assembly and/or of the housing,
wherein the sensor device is configured for the arrangement downstream from the closure element of the condensate drain and for detecting at least one of the following:
a leakage of the condensate drain by detecting the structure-borne sound of the coupling assembly and/or of the housing,
a blockage of the flow path by detecting the temperature of the coupling assembly of the housing, and/or
wherein the coupling assembly has the coupling part, which is configured for the releasable connection to the housing, and an adapter, which is configured for connecting the sensor to the coupling part so as to conduct structure-borne sound temperature, and/or
wherein the coupling assembly comprises:
the coupling part, which can be brought into engagement with the corresponding coupling interface of the housing in a releasable manner,
the holding part, which is connected indirectly to the housing and so as to conduct structure-borne sound and which is configured for the positive and/or non-positive connection to a first sensor and for the at least indirect connection to the coupling part, and
a sensor receptacle, which is assigned to the holding part and which is configured for receiving a second sensor for detecting the temperature.

18. A method for detecting a state or a blockage and/or leakage of the flow path, in particular for the condensate drain according to claim 1, comprising the steps of:
providing the sensor device,
structure-borne sound-conducting connection of the sensor device to the housing of the condensate drain by means of the coupling assembly, wherein the coupling assembly is connected in a positive and/or non-positive manner to the sensor and is configured for establishing a releasable, positive and/or non-positive connection to the housing and/or a temperature of the coupling assembly and/or of the housing, in order to conduct the structure-borne sound of the housing to the sensor in the mounted state,
conducting the structure-borne sound by means of the coupling assembly to at least one sensor,
detecting structure-borne sound and/or temperature by means of the sensor,
providing at least one sensor signal by means of the sensor,
sending the sensor signal to an evaluation unit, and
evaluating the sensor signal of the sensor,
wherein the sensor preferably detects the structure-borne sound and the method preferably further comprises the steps of:
providing at least one second sensor signal by means of a temperature sensor,
sending the second sensor signal to the evaluation unit and
jointly evaluating the sensor signal of the first sensor and of the temperature sensor.
